(19) United States
(12) Patent Application Publication
(10) Pub. No.: US 2007/0188316 A1
(43) Pub. Date: Aug. 16, 2007

(54) PARKING BRAKE OFF WARNING SYSTEM

(75) Inventor: Kevin Joe Dean, Rockmart, GA (US)

Correspondence Address: Mr.Kevin Joe Dean, 530 Old Cedartown Road, Rockmart, GA, 30153, US

(73) Assignee: Mr. Kevin Joe Dean, Rockmart, GA (US)

(21) Appl. No.: 11/307,535

(22) Filed: Feb. 11, 2006

(51) Int. Cl. B60Q 1/00; G08B 21/00

(52) U.S. Cl. 340/457.3; 340/686.1

(57) ABSTRACT

A warning system for vehicles with a manually applied parking brake. The warning system combines an audio and visual warning to the operator of the vehicle that the parking brake has not been applied.

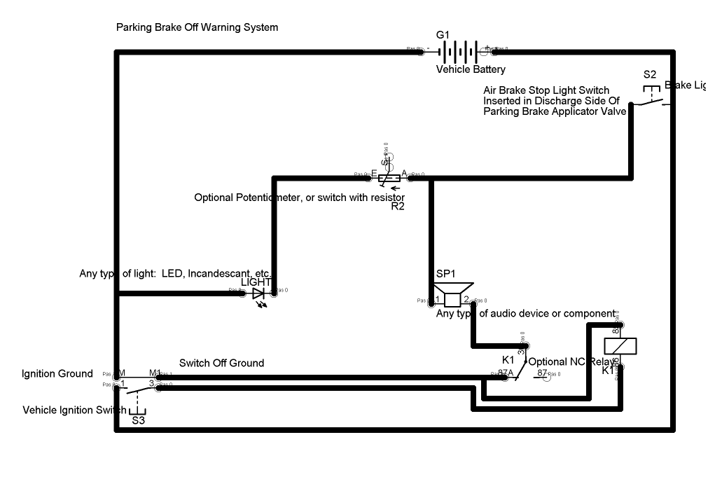

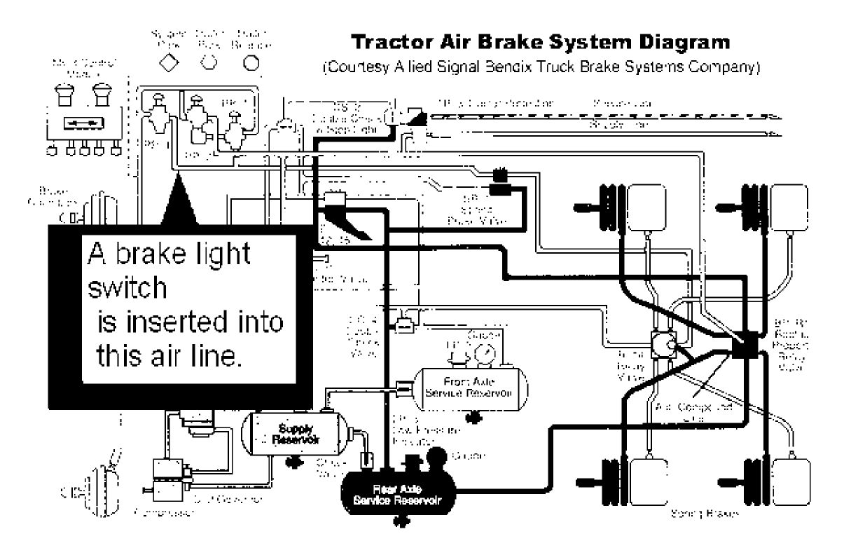

### DESCRIPTION

### TECHNICAL

This invention generally relates to any air brake system where the parking brake has to be manually applied by the operator and, more particularly, is a warning system to alert the operator that the parking brake has not been applied.

### BACKGROUND

Many serious accidents, injuries and deaths occur each year due to the operator of vehicles with this type of brake system failing to apply the parking brake before exiting the vehicle. This system will reduce and possibly eliminate these accidents.

### SUMMARY OF INVENTION

This system consists of: 1. A light. 2. A small alarm or similar audio device. 3. An air brake system brake light switch. 4. An optional potentiometer or an on/off switch in series with a resistor inserted in-line with the light to dim the light at night. 5. An optional “normally closed” relay switch for vehicle ignition systems that do not have an ignition “switch off ground”. All or part of these items may be assembled inside a box to form a module or device or may be installed in or under the dash of the vehicle or in any arrangement desired by the installer. For this system to work, a brake light switch, such as is used in a standard air brake system, would have to be inserted into the discharge side of the Parking Brake Actuator Valve. When the parking brakes are released air pressure would activate this brake light switch sending current to the light and to the alarm. The light would remain on the entire time the tractor is being operated with its parking brakes off as a reminder to the driver. Also, if the vehicle's ignition switch does not have a “switch off ground” (a terminal on the switch that connects to the vehicle battery ground, or negative post, when the switch is off) then a “normally closed relay” will have to be installed to provide battery ground to the alarm when the vehicle ignition switch is off. Turning the ignition key on would negate the ignition “key off ground” if so equipped or open the “normally closed relay” to disconnect the alarm from the vehicle battery's ground or negative side. After parking his unit, the driver can tell if his parking brakes are not set by looking to see if the light is on. In addition, if the driver turns off his ignition without setting his parking brakes, the alarm will sound.

### BRIEF DESCRIPTION OF DRAWINGS

Picture 1. A schematic of the system including the vehicle key ignition switch.

Picture 2. Shows the air line into which the brake light switch is to be inserted into the air brake system. Alternatively, the switch can be installed at either end of the air line and/or installed into the parking brake application valve or Parking Brake Relay Valve. If the switch is installed inside a box or module, a “T” and another air line must be installed to connect the switch with the Parking Brake Application system.

### DESCRIPTION OF PREFERRED EMBODIMENTS

As shown in the schematic in picture 1 the system is built using a light and an alarm or buzzer. A standard parking brake light switch for air brake systems is installed into the discharge side of the Parking Brake Actuator Valve in any manner desired. In Vehicles whose ignition switch does not have a “key off ground” feature a “normally closed relay” is used to provide connection to the vehicle battery's ground post when the ignition key is in the off position. Optionally, a potentiometer or similar device can be installed in line with the light to add a “dimmer” feature to dim the light if necessary for operation at night. It is within the ambit of the present invention to cover any obvious modifications of the embodiments described herein, provided such modifications fall within the scope of the appended claims.

What is claimed is:

1. A “parking brake off warning system” consisting of three primary components and two optional components. The three primary components consist of a light (any type of light, whether incandescent, LED, etc.), an air brake system brake light switch and an alarm or any type of audio device. The two optional components consist of a normally closed relay and a potentiometer for dimming the light or, in place of a potentiometer, an on/off switch with an in-line resistor of any value. All or part of these components may be assembled in the vehicle in any arrangement desired, whether under the dash, as part of the dash, in the instrument cluster, etc.

2. A module or device containing all or part of the components in claim 1 assembled inside any type and size of box (plastic, metal, etc.) with electrical connections and/or wire leads, etc. and any type of air connection for the air brake light switch, if the brake light switch is installed in the module or device, to aid in easily connecting the resulting module or device to the vehicle's air and electrical system.
